(19) United States
(12) Patent Application Publication
(10) Pub. No.: US 2026/0328683 A1
(43) Pub. Date: Oct. 22, 2026

(54) TURBIDITY SENSOR FOR MEASURING TURBIDITY OF A FLUID

(71) Applicant: SENSIRION AG, Staefa ZH (CH)

(72) Inventors: Maxime BROSSET, Staefa (CH); Raffaele DI GIACOMO, Staefa (CH)

(73) Assignee: SENSIRION AG, Staefa ZH (CH)

(21) Appl. No.: 19/105,880

(22) PCT Filed: Aug. 31, 2023
(86) PCT No.: PCT/EP2023/073960

§ 371 Date: Feb. 24, 2025

(30) Foreign Application Priority Data
Aug. 31, 2022 (EP) 22193315.3

(51) Int. Cl. G01N 21/47; G01N 21/51; G01N 21/53

(52) U.S. Cl. CPC G01N 21/4738; G01N 21/51; G01N 21/53

(57) ABSTRACT

The invention relates to a turbidity sensor (1) for measuring turbidity of a fluid, wherein the turbidity sensor (1) comprises: a container (2) delimiting a cavity (3) of the container (2) configured to receive said fluid, a first source of electromagnetic radiation (4) configured and arranged to generate and emit electromagnetic radiation (11) into the cavity (3) of the container (2), and a photodetector (5) configured and arranged to detect electromagnetic radiation scattered by the fluid (12).

The present invention relates to a turbidity sensor for measuring turbidity of a fluid.

Generally, turbidity describes a cloudy appearance of a fluid, particularly of a liquid, caused by microscopic particles suspended in the fluid. Because of gravity, heavier particles tend to settle at a bottom of a container comprising the fluid with the particles, while lighter particles may remain in a state of suspension, causing substantial reflection, absorption and refraction to incoming light, which may result in a cloudy appearance of the fluid. For example, in the case of drinking water, potentially hazardous contaminants such as bacteria or viruses may be attached to particles suspended in the drinking water. Moreover, pollution in natural waters such as lakes or oceans also result in turbidity. As such, turbidity represents an essential parameter to assess the quality and purity of the fluid, which finds applications in various fields.

To determine or measure turbidity, various turbidity sensors are known from the prior art. For example, EP1659394 discloses a turbidity measuring system with a chamber for a sample liquid, an inlet and an outlet as well as an immersed sensor unit comprising a light source and a detector. However, the sensor unit immersed into the liquid in the chamber and the geometry of the chamber can be disadvantageous in that the detected light for determining the turbidity may comprise light which is not scattered from particles, giving rise to artefacts in the measured turbidity. Moreover, because of the arrangement of the light source and the detector of the sensor unit in the chamber, bubbles in the liquid tend to move through the optical path between the light source and the detector, causing additional spurious scattering which further distorts the turbidity reading.

JP2013036807 shows a device for measuring turbidity with a parabolic mirror for focusing light scattered from particles within the fluid onto a detector. However, the device requires a focused light beam so as to avoid an exposure of the parabolic mirror with light which is not scattered from particles within the fluid. This can lead to relatively low scattering and thus low signals detected by the detector. At the same time, the scattered electromagnetic radiation may miss the parabolic mirror, further decreasing the detected signal.

Based on this, the problem to be solved by the present invention is to provide a cost-efficient turbidity sensor which allows for a reliable measurement of the turbidity of a fluid.

This task is solved by a turbidity sensor having the features of claim 1.

Advantageous embodiments of the invention are stated in the corresponding dependent claims and described in the following.

The invention relates to a turbidity sensor for measuring turbidity of a fluid, wherein the turbidity sensor comprises:
a container delimiting a cavity of the container configured to receive said fluid,
a first source of electromagnetic radiation configured and arranged to generate and emit electromagnetic radiation into the cavity of the container and
a photodetector configured and arranged to detect electromagnetic radiation scattered by the fluid.

The turbidity sensor is characterized in that the container comprises a concave inner surface facing the cavity and facing the first source of electromagnetic radiation, wherein the concave inner surface is configured to absorb at least a majority of the electromagnetic radiation impinging onto the concave inner surface, and wherein the cavity further comprises a bottom surface arranged opposite of the concave inner surface and an exit for transmission of the electromagnetic radiation scattered by the fluid out of the cavity and towards the photodetector.

In the context of the present invention, the term ‘electromagnetic radiation scattered by the fluid’ or ‘scattered electromagnetic radiation’ denotes a first fraction of the electromagnetic radiation emitted from the first source of electromagnetic radiation which, prior to or after one or more reflections from walls of the container, scatters by particles within the fluid.

In turn, a second fraction of the electromagnetic radiation emitted from the first source of electromagnetic radiation is not scattered by particles within the fluid. This non-scattered electromagnetic radiation may however suffer one or more reflections from walls of the container, particularly from the concave inner surface and the bottom surface of the container.

A ‘fluid’ in the context of this invention may for example comprise or be a liquid or a mixture of liquids, particularly a liquid or a liquid mixture comprising particles. The ‘fluid’ may comprise or be a suspension.

According to the invention, a majority of the electromagnetic radiation impinging onto the concave inner surface is absorbed by the inner surface, such that the probability for detection of electromagnetic radiation not scattered by particles within the fluid by the photodetector is advantageously reduced.

For example, the concave inner surface comprises acrylonitrile butadiene styrene (ABS), preferably black ABS, making it easy and cheap to fabricate while providing an absorption of the majority of the electromagnetic radiation. Other (preferably black) plastic materials can also be used.

By the choice of a concave inner surface arranged opposite of the first source of electromagnetic radiation, trajectories of photons of the non-scattered electromagnetic radiation and/or a corresponding radiation density of the photons of the non-scattered electromagnetic radiation may be controlled to the extent that for a given position of the first source of electromagnetic radiation relative to the container, the trajectories of the photons and/or their spatial density within the cavity favor specific areas of the cavity defined by the geometry of the boundaries of the container, particularly the concave inner surface, defining an intrinsic spatial radiation density of the cavity itself. In turn, the fluid, particularly particles within the fluid, acts like a scatterer for the electromagnetic radiation due to reflection, absorption and/or refraction of the electromagnetic radiation, which changes the distribution of photons or their radiation density within the cavity, compared to the intrinsic spatial radiation density of the cavity.

Preferably, in an embodiment, the first source of electromagnetic radiation is configured to generate and emit infrared light into the cavity of the container. For example, in a preferred embodiment, the first source of electromagnetic radiation may be configured to generate and emit infrared light with a wavelength between 820 nm and 900 nm, particularly approximately 860 nm.

Particularly, in an embodiment, the photodetector produces an output signal based on the detected scattered electromagnetic radiation, wherein the output signal is indicative of the turbidity of the fluid, particularly the liquid, inside the container.

Preferably, according to an embodiment, the bottom surface is configured to absorb a majority of the electromagnetic radiation impinging onto the bottom surface, such that the probability for detection of electromagnetic radiation not scattered by particles within the fluid by the photodetector is advantageously reduced. The bottom surface can comprise ABS in a preferred embodiment.

Furthermore, according to an embodiment, the electromagnetic radiation impinging onto the concave inner surface may be reflected back to the concave inner surface by the bottom surface, such that multiple reflections within the container between the inner concave surface and the bottom surface are possible. Particularly, in an embodiment, the bottom surface is a planar surface forming a bottom of the container along a vertical extension direction through the vertex of the concave inner surface of the container, wherein the vertex of the concave inner surface forms the highest point of the cavity along the vertical extension direction. As such, the container may form a lower cylindrical section, wherein one end of the cylindrical section is closed by the bottom surface, and wherein an upper section with a dome- or cone-shape comprising the concave surface adjoins the cylindrical section so as to at least partially close the container.

Particularly, according to an embodiment, a section of the concave inner surface of the container comprises a cross-sectional contour in a plane normal to the bottom surface, wherein the cross-sectional contour is parabolic, piecewise linear, or forms a circular arc. As such, in three dimensions, the upper section of the container, particularly the concave inner surface, may form a section of a paraboloid, a cylinder, a cone-topped cylinder, or a section of sphere, particularly at least a section of a hemisphere.

According to an embodiment, the concave inner surface is configured to contain electromagnetic radiation reflected off the concave inner surface within the cavity. In particular, the concave inner surface is configured to reflect a fraction of the electromagnetic radiation impinging onto the concave inner surface so as to contain the electromagnetic radiation reflected off the concave inner surface within the cavity. The geometry of the concave inner surface causes the containment of the reflected electromagnetic radiation, as it allows for control of the direction of the reflected electromagnetic radiation.

Furthermore, particularly, a majority of the electromagnetic radiation impinging onto the concave inner surface is absorbed by the concave inner surface. By the reflection of the remaining minority of the electromagnetic radiation not absorbed by the concave inner surface, the remaining minority of electromagnetic radiation is contained within the cavity and thus not transmitted out of the cavity via the exit, which advantageously enhances the sensitivity of the turbidity sensor.

In another preferred embodiment, the first source of electromagnetic radiation is arranged such that the electromagnetic radiation is emitted into the cavity through a window forming at least a section of the bottom surface. More particularly, the window forms the entire bottom surface.

In another preferred embodiment, the exit is arranged adjacent to the concave inner surface. Particularly, the exit is arranged in a section of the container extending between the concave inner surface of the container and the bottom surface of the container. As such, the exit may be located in an area of the container with a considerably lower radiation density compared to the concave inner surface, which is exposed by the non-scattered electromagnetic radiation emitted by the first source of electromagnetic radiation. However, as pointed out above, the scattered electromagnetic radiation causes increased radiation densities in areas that, without scattering, would comprise low radiation densities. As such, arranging the exit adjacent to the concave inner surface causes a lower probability for the non-scattered electromagnetic radiation to be transmitted through the exit of the cavity and towards the photodetector, which would result in a signal detected by the photodetector which is not related to scattered electromagnetic radiation. At the same time, arranging the exit adjacent to the concave inner surface allows for an efficient detection of the scattered electromagnetic radiation, which is more likely to transmit out of the cavity in this particular arrangement of the exit. Particularly, the exit forms an optically transparent section of a lateral wall of the container. For example, in case of a lateral wall with a closed cross-section in a view normal to the lateral wall, the exit may be formed circumferentially around the cavity enclosed by the lateral wall. Preferably, sections of the lateral wall of the container that do not form the exit comprise an inner surface facing the cavity, wherein the inner surface comprises ABS. As such, the inner surface of the lateral wall may be configured to absorb a majority of the electromagnetic radiation impinging onto the inner surface of the lateral wall, such that the probability for detection of electromagnetic radiation not scattered by particles within the fluid by the photodetector is advantageously reduced.

According to yet another embodiment, which particularly allows to omit the detection chamber, the exit forms an optically transparent section of a lateral wall of the container and is preferably extruded to form a waveguide that ends directly on, or in line with, the photodetector.

Particularly, according to a preferred embodiment, the container comprises or consists of ABS.

According to another preferred embodiment, the turbidity sensor further comprises a detection chamber with an inner surface configured to deflect, particularly to reflect the scattered electromagnetic radiation transmitted through the exit to the photodetector. Preferably, the detection chamber is separated from the cavity via an optically transparent wall section of the container, wherein the transparent wall section forms the exit. The inner surface of the detection chamber may for example be concave, circular, or oriented at an angle, preferably an angle of approximately 45° relative to a direction along which the scattered electromagnetic radiation enters the detection chamber, such that the scattered electromagnetic radiation is deflected, particularly reflected towards the photodetector. As such, the scattered electromagnetic radiation is effectively detected by the photodetector and not reflected back into the cavity of the container. Preferably, the detection chamber and thus the photodetector are separated from the fluid inside the container at least by the optically transparent wall section forming the exit, such that the fluid is not contacting the inner surface of the detection chamber and the photodetector.

Preferably, in an embodiment, the detection chamber is filled with a gas. For example, the gas may comprise or be air. In other words, the detection chamber preferably does not comprise a liquid, such that no further scattering of the scattered electromagnetic radiation may occur within the detection chamber prior to or after the deflection or reflection from the inner surface of the detection chamber, such that backscattering of the scattered electromagnetic radiation back into the cavity is strongly suppressed. To confine the gas in the detection chamber, the detection chamber is separated from the cavity, at least partly by said exit, and may additionally be separated from the downstream photodetector by a window of the detection chamber arranged between the detection chamber and the photodetector.

In an alternative embodiment, the detection chamber is filled with ambient air and the window of the detection chamber is replaced by an opening.

In yet another embodiment, the container further comprises an inlet and an outlet configured to receive a fluid flow passing said fluid into and out of the cavity of the container.

Particularly, the cavity, the inlet and the outlet are configured to force the fluid to form a vortex of the fluid flow. As such, the turbidity sensor may be configured to cause a centrifugation of the fluid, wherein i) the fluid is moved relative to the container, such that particularly particles within the fluid may be effectively exposed to the electromagnetic radiation and wherein ii) gaseous components, particularly bubbles entrained within the fluid are confined and thus separated from the rest of the fluid to an area around a vortex axis around which the vortex is formed, minimizing the signal detected by the photodetector which is not related to scattered electromagnetic radiation because of scattering of electromagnetic radiation by bubbles. Particularly, the vortex axis extends through a center of said vortex.

Preferably, the outlet is arranged in a vicinity of the vertex of the concave inner surface and the inlet is arranged in the lateral wall of the container, such that the fluid flow can be passed through the inlet to flow along the lateral wall so as to form a vortex. More preferably, the lateral wall comprises a circular cross-section, such that the vortex is formed by guiding the fluid flow from the inlet along the circular wall toward the outlet of the container.

For example, the fluid flow may be generated by a flow generating unit of the turbidity sensor, such as a pump or alternatively by an external fluid supply.

According to an embodiment, the first source of electromagnetic radiation is arranged and configured such that the electromagnetic radiation is emitted into the cavity of the container along an axis which is offset from the central axis through the vortex. As such, the electromagnetic radiation may be emitted in a controlled manner along an axis offset from the vortex axis where bubbles entrained within the fluid are mostly confined, such that absorption, reflection and/or refraction of the electromagnetic radiation due to interactions with the bubbles is advantageously suppressed, as the latter could cause signals detected by the photodetectors which are not related to scattering by particles within the fluid.

In another embodiment, the outlet comprises a distance from the bottom surface which is larger than a distance between the inlet and the bottom surface. As such, the fluid flow may extend three-dimensionally from the inlet arranged closer to the bottom surface up to the outlet arranged further away from the bottom surface, wherein the vortex may form a three-dimensional vortex tube.

In yet another embodiment, the turbidity sensor further comprises a second source of electromagnetic radiation configured to generate and emit ultraviolet (UV) electromagnetic radiation into the cavity of the container to prevent a formation of biofilms inside the container. Preferably, in this embodiment, the exit is formed by a window which is optically transparent for the electromagnetic radiation generated and emitted into the cavity by the first source of electromagnetic radiation, wherein the window is opaque for the electromagnetic radiation generated and emitted into the cavity by the second source of electromagnetic radiation. As an advantageous consequence, the turbidity of the liquid may be measured by means of the detected scattered electromagnetic radiation of the first source of electromagnetic radiation, while the electromagnetic radiation of the second source of electromagnetic radiation cannot transmit through the exit and remains in the cavity, such that it is not detected by the photodetector and such the formation of biofilms is prevented effectively.

Particularly, the turbidity sensor may be part of a system for measuring turbidity of a fluid. The system for measuring turbidity of a fluid may further comprise a processing unit configured to receive said output signals from the photodetector, wherein the output signals are indicative for the scattered electromagnetic radiation detected by the photodetector. To this end, the photodetector may for example comprise or be a photodiode producing an electronic output signal indicative of the detected scattered electromagnetic radiation. The processing unit may be configured to determine, particularly to calculate a value indicative for the turbidity of the fluid within the container based on the output signals received from the photodetector, particularly based on an intensity of the scattered electromagnetic radiation. The processing unit may further be configured to determine the value indicative for the turbidity of the fluid based on the electromagnetic radiation generated and emitted into the cavity by the first source of electromagnetic radiation, particularly based on an intensity of the electromagnetic radiation. The processing unit may also be configured to determine the value indicative of the turbidity of the fluid based on a ratio between the scattered electromagnetic radiation detected by the photodetector and the electromagnetic radiation emitted into the cavity by the first source of electromagnetic radiation. For example, the processing unit may be configured to determine, particularly to calculate, the value indicative of the turbidity of the fluid by means of a value in Formazin Turbidity Units (FTU) based on ISO 7027. Particularly, the processing unit may be configured to determine, particularly to calculate a concentration of particles suspended in the fluid, particularly the liquid inside the container.

Exemplary embodiments are described below in conjunction with the Figures. The Figures are appended to the claims and are accompanied by text explaining individual features of the shown embodiments and aspects of the present invention. Each individual feature shown in the Figures and/or mentioned in the text of the Figures may be incorporated (also in an isolated fashion) into a claim relating to the turbidity sensor according to the present invention. Particularly,

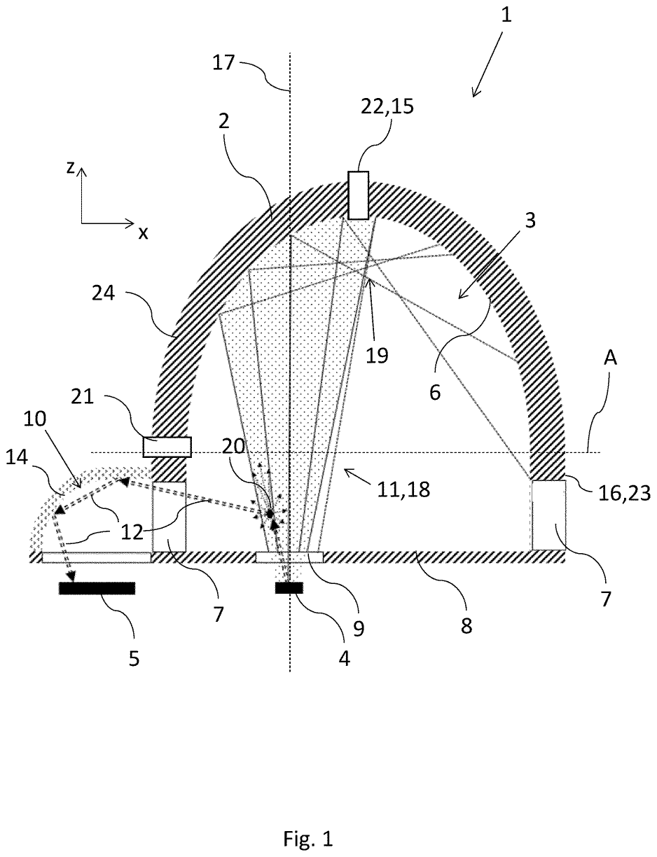

FIG. 1 shows a first view in an x-z-plane of an exemplary embodiment of the turbidity sensor,

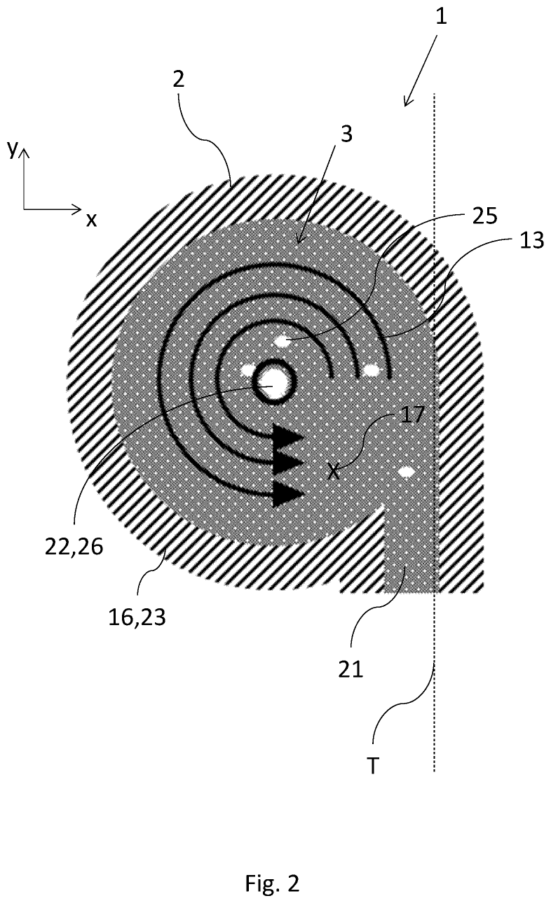

FIG. 2 shows a second view in a sectional x-y-plane of the exemplary embodiment of the turbidity sensor shown in FIG. 1, and

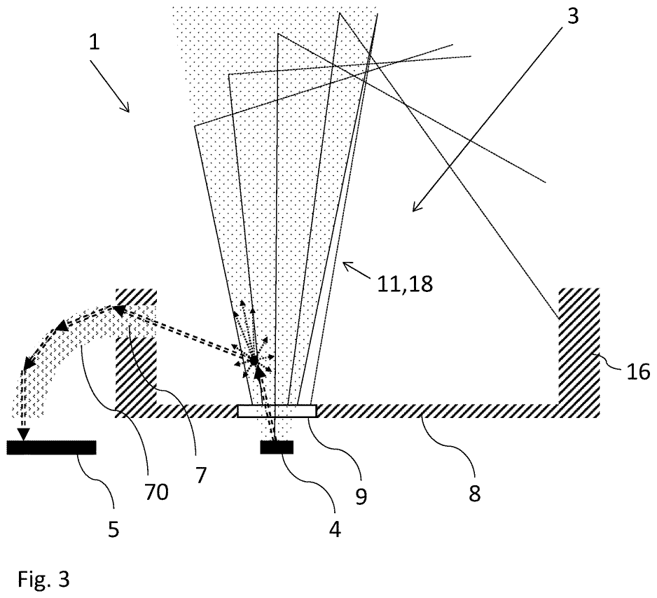

FIG. 3 shows a further embodiment a turbidity sensor according to the present invention.

FIG. 1 shows an exemplary embodiment of the turbidity sensor 1 in a cross-sectional view along an x-z-plane through the container 2 of the turbidity sensor 1. According to the invention, the turbidity sensor 1 further comprises a first source of electromagnetic radiation 4 configured to generate and emit electromagnetic radiation 11 into a cavity 3 delimited by the container 2. In this exemplary embodiment, an optically transparent window 9 is arranged between the first source of electromagnetic radiation 4 and the cavity 3, such that the electromagnetic radiation 11 generated by the first source of electromagnetic radiation 4 is emitted into the cavity 3 via said window 9. The turbidity sensor 1 further comprises a photodetector 5, particularly a photodiode, for detection of scattered electromagnetic radiation 12, wherein the scattered electromagnetic radiation 12 is scattered from particles 20 suspended within the fluid, particularly the liquid filling the container 2 when the turbidity sensor 1 is in use.

As can be seen in FIG. 1, the scattered electromagnetic radiation 12 is transmitted out of the cavity 3 through an exit 7 into a detection chamber 10 of the turbidity sensor 1. The detection chamber 10 comprises an inner surface 14 which is curved and serves to deflect the scattered electromagnetic radiation 12 entering the detection chamber 10 towards the photodetector 5. As such, a backscattering of the scattered electromagnetic radiation 12 back into the cavity 3 is effectively suppressed. Preferably, the detection chamber 10 is filled with a gas or is evacuated and does not comprise a liquid, such that no further scattering from particles 20 occurs within the detection chamber 10, which could lead to backscattering back into the cavity 3 and thus a lower detection signal detected by the photodetector 5.

A lower section 23 of the container 2 may comprise a circular cross-section when viewed in a sectional plane A corresponding to the x-y-plane, as shown in FIG. 2. As such, a lateral wall 16 delimiting the cavity 3 in the lower section 23 of the container 2 may form a circumferential wall, wherein the exit 7 forms an optically transparent section of the circumferential wall, such that the exit 7 extends around the cavity 3 in the lower section 23 of the container 2. This is easy and inexpensive to realize in terms of production technology and enables an efficient transmission of scattered electromagnetic radiation 12 out of the cavity 3. On its bottom side, the cavity 3 is delimited by a bottom surface 8 of the container 2, wherein said window 9 for emission of the electromagnetic radiation 11 into the cavity 3 forms at least a section of the bottom of the container 2. Adjacent to the lower section 23, an upper section 24 of the container 2 forms a concave inner surface 6 facing the first source of electromagnetic radiation 4. Particularly, in three dimensions, the concave inner surface 6 may be a section of a paraboloid or a section of a sphere, particularly at least a section of a hemisphere. The concave inner surface 6 of the container 2 delimits a convex part of the cavity 3.

For example, a height of the cavity 3 as measured from the bottom surface 8 to the outlet 22 is 3 cm, a maximal x-y-diameter of the cavity 3 can be about 2.5 cm, and a maximal x-y-diameter of the container can be about 3.3 cm.

In this example embodiment, the concave inner surface 6 is approximately parabolic within the shown x-z-plane, such that the electromagnetic radiation 11 emitted into the cavity 3 along or around an axis 17 and that is not absorbed by the material of the concave inner surface 6, such as ABS, is reflected towards a focusing region 19 of the cavity 3, wherein the area of the focusing region 19 depends on the geometry of the concave inner surface 6. Exemplary photon trajectories 18 are sketched to illustrate the containment properties of the concave inner surface 6 and the corresponding focusing region 19. As such, the geometry of the container 2, particularly the concave inner surface 6, allows to control, particularly to concentrate the spatial radiation density of electromagnetic radiation 11 not scattered by particles 20 in the fluid to a focusing region 19 inside the container 2.

While the electromagnetic radiation 11 which is not scattered by particles 20 within the liquid is concentrated in the focusing region 19, the scattered electromagnetic 12 radiation exhibits a different dynamic, which depends not only on the geometry of the cavity 2, but also on the location and number of the scattering events inside the container 2 as well as the shape and the optical properties of the particle 20. Particularly, the scattered electromagnetic radiation 11 tends to expose areas of the container 2 which are less likely to be exposed by the non-scattered electromagnetic radiation 11, whose dynamic is primarily governed by the geometry of the container 2. As can be seen in FIG. 1, the exit 7 is located in a section of the container 2 extending between the concave inner surface 6 and the bottom surface 8 of the container 2. As such, the probability for scattered electromagnetic radiation 12 to reach the exit 7 is advantageously enhanced by the particular arrangement of the exit 7 within the container 2, wherein the non-scattered electromagnetic radiation 11 tends not to reach this area and thus to remain inside the container 2. As an advantageous consequence, the signal detected by the photodetector 5 comprises a larger fraction of detected scattered electromagnetic radiation 12 over non-scattered electromagnetic radiation 11, which enhances the sensitivity of the turbidity sensor 1.

Moreover, the container comprises an inlet 21 and an outlet 22 configured to pass a fluid, particularly a liquid, into the container 2, which is further addressed in FIG. 2.

FIG. 2 shows a cross-sectional view along the sectional plane A indicated in FIG. 1, highlighting the circumferential lateral wall 16 delimiting the lower section 23 of the container 2 along the x- and the y-direction. The inlet 21 is arranged parallel to a tangent T of an imaginary circle defined by an inside of the circumferential lateral wall 16. The outlet 21 is located at the top of the container 2 when viewed in the x-z-plane (cf. FIG. 1) and in the center of the circle, when viewed in the x-y-plane (cf. FIG. 2). By introducing the fluid, particularly the liquid, into the container 2 via the inlet 21, the fluid is guided along the inside of the circumferential lateral wall 16 and upwards to the outlet 22, such that a vortex 13 is formed within the cavity 3. For the dimensions of the cavity 3 as described above, a fluid flow of 0.5 liters per minute or greater has been found to be sufficient to generate a vortex 13. As sketched in FIG. 2, the vortex 13 allows for separation of gaseous components 25, particularly bubbles, in the area of the vortex axis 26, such that the gaseous components 25 are spatially separated from the rest of the fluid. The indicated axis 17 along or around which the electromagnetic radiation 11 is offset from the vortex axis 26, which advantageously contributes to less scattering from the gaseous components 25, which is known to deteriorate the detection efficiency of the electromagnetic radiation 12 that is actually scattered from particles 20.

Furthermore, FIG. 3 shows a further embodiment, particularly a modification of the embodiment according to FIG. 2, wherein here, the detection chamber 10 is absent and the light exit 7 comprises a waveguide 70 extending from the lateral wall 16 of the container 2/cavity 3 to the photodetector 5.

This waveguide 70 can, in one embodiment, have a curved shape to allow the light collected at the exit 7 to reach the photodetector 5 positioned at any desired angle with respect to the chamber wall.

### LIST OF REFERENCE SIGNS

Turbidity sensor 1
Container 2
Cavity 3
First source of electromagnetic radiation 4
Photodetector 5
Concave inner surface 6
Exit 7
Bottom surface 8
Window 9
Detection chamber 10
Electromagnetic radiation 11
Scattered electromagnetic radiation 12
Vortex 13
Inner surface of the detection chamber 14
Vertex 15
Lateral wall 16
Axis 17
Trajectories 18
Focus region 19
Particle 20
Inlet 21
Outlet 22
Lower section of the container 23
Upper section of the container 24
Gaseous components 25
Vortex axis 26
Sectional plane A
Tangent T
Waveguide 70

1. A turbidity sensor (1) for measuring turbidity of a fluid, wherein the turbidity sensor (1) comprises:
a container (2) delimiting a cavity (3) of the container (2) configured to receive said fluid,
a first source of electromagnetic radiation (4) configured and arranged to generate and emit electromagnetic radiation (11) into the cavity (3) of the container (2) and
a photodetector (5) configured and arranged to detect electromagnetic radiation scattered by the fluid (12),
characterized in that the container (2) comprises a concave inner surface (6) facing the cavity (3) and facing the first source of electromagnetic radiation (4), wherein the concave inner surface (6) is configured to absorb at least a majority of the electromagnetic radiation (11) impinging onto the concave inner surface (6), and wherein the container (2) further comprises a bottom surface (8) arranged opposite of the concave inner surface (6) and an exit (7) for transmission of the electromagnetic radiation scattered by the fluid (12) out of the cavity (3) and towards the photodetector (5).

2. The turbidity sensor (1) according to claim 1, wherein the concave inner surface (6) is configured to contain electromagnetic radiation (11) reflected off the concave inner surface (6) within the cavity (3).

3. The turbidity sensor (1) according to claim 1, wherein the first source of electromagnetic radiation (4) is arranged such that the electromagnetic radiation (11) is emitted into the cavity (3) through a window (9) forming at least a section of the bottom surface (8).

4. The turbidity sensor (1) according to claim 1, wherein the exit (7) is arranged adjacent to the concave inner surface (6).

5. The turbidity sensor (1) according to claim 1, wherein the exit (7) is arranged in a section of the container (2) extending between the concave inner surface (6) of the container (2) and the bottom surface (8) of the container (2).

6. The turbidity sensor (1) according to claim 1, further comprising a detection chamber (10) with an inner surface (14) configured to reflect the scattered electromagnetic radiation (12) transmitted through the exit (7) to the photodetector (5).

7. The turbidity sensor (1) according to claim 6, wherein the detection chamber (10) is filled with a gas.

8. The turbidity sensor (1) according to claim 1, wherein the exit (7) forms an optically transparent section of a lateral wall (16) of the container (2).

9. The turbidity sensor according to claim 1, wherein the exit (7) forms an optically transparent section of a lateral wall (16) of the container (2) and is extruded to form a waveguide (70) that leads to the photodetector and particularly ends thereon.

10. The turbidity sensor (1) according to claim 1, wherein the container (2) further comprises an inlet (21) and an outlet (22) configured to receive a fluid flow passing said fluid into and out of the cavity (3) of the container (2).

11. The turbidity sensor (1) according to claim 10, wherein the cavity (3), the inlet (21) and the outlet (22) are configured to force the fluid to form a vortex (13) of the fluid flow.

12. The turbidity sensor (1) according to claim 10, wherein the outlet (22) is arranged in a vicinity of the vertex (15) of the concave inner surface (6) and the inlet (21) is arranged in the lateral wall (16) of the container (2), such that the fluid flow can be passed through the inlet (21) to flow along the lateral wall (16) so as to form a vortex (13).

13. The turbidity sensor (1) according to claim 11, wherein the first source of electromagnetic radiation (4) is arranged and configured such that the electromagnetic radiation (11) is emitted into the cavity (3) of the container (2) along an axis (17) which is offset from a vortex axis (26) of the vortex (13).

14. The turbidity sensor (1) according to claim 10, wherein the outlet (22) comprises a distance from the bottom surface (8) which is larger than a distance between the inlet (21) and the bottom surface (8).

15. The turbidity sensor (1) according to claim 1, further comprising a second source of electromagnetic radiation configured to generate and emit ultraviolet (UV) electromagnetic radiation into the cavity (3) of the container (2) so as to prevent a formation of biofilms inside the container (2).

16. The turbidity sensor (1) according to claim 1, wherein a section of the concave inner surface (6) of the container (2) comprises a cross-sectional contour in a plane normal to the bottom surface (8), wherein the cross-sectional contour is parabolic, piecewise linear or forms a circular arc.
